(19) United States
(12) Patent Application Publication
(10) Pub. No.: US 2007/0125807 A1
(43) Pub. Date: Jun. 7, 2007

(54) Dispenser for discharging a measured amount of various liquids from their container

(76) Inventors: Kelly Lucas, Wasilla, AK (US); Benjamin Lee Chong, Renton, WA (US)

Correspondence Address: Eugene Oak, Ph.D., J.D., M.Div.;Law Office of Jane Oak and Associates, P.C., Suite # 2470, 3435 Wilshire Blvd., Los Angeles, CA, 90010, US

(21) Appl. No.: 11/294,104

(22) Filed: Dec. 6, 2005

(51) Int. Cl. G01F 11/10

(52) U.S. Cl. 222/361

(57) ABSTRACT

A dispenser to discharge a measured amount of liquid from a reservoir is provided. The liquids in the reservoir may be water, liquid medicine, and/or corrosive chemicals. The dispenser of the current application is comprised of a) a long cubic module for measuring liquid volume that has an open space of straight pipe which is developed vertically between the middle and the rear side thereof, b) a guiding case for the long cubic module that surrounds the module with five walls of two side walls, one rear wall, one upper wall, and a lower wall and has a screwed receptor for the liquid container and an air hole on the upper wall and has a square opening at the lower wall, c) a telescopic plastic case located horizontally on inside of the rear wall of the guiding case, and d) a spring placed inside of the telescopic plastic case. Two O-rings are engaged to two O-ring grooves that are developed at both ends of the open space of straight pipe. The volume of the open space of straight pipe is adjusted by inserting an inert ball of known volume.

### 1. FIELD OF THE INVENTION

Current application relates to a liquid dispenser, more specifically, a dispenser discharging a measured amount of various liquids from their container.

### 2. BACKGROUND OF THE INVENTION

Most liquid dispensers developed up to now control the amount of the dispensed liquid by observation of the operator of the dispenser, such as a beverage dispenser in a snack shop. Some kinds of dispensers control the amount of liquid dispensed by measuring the weight of the cup and contents. One example is the mouth washing water dispenser in a dental clinic. However, those electrically controlled dispensers require an electrical pump, solenoid valves, and a microprocessor. Such equipment not only requires much space, though they are hidden in a dental chair, but it is also quite expensive. Another type of dispenser for discharging a measured amount of material is a powder dispenser. These dispensers have a simple structure of a drawer under a hopper. However, these dispensers cannot handle liquid in precise amounts. It is the purpose of the current application to provide a cheap and easy-to-handle dispenser that can discharge a precise amount of various liquid from their containers with simple operation.

### DESCRIPTION OF THE PRIOR ART

U.S. Pat. No. 2,003,562 to Stuart, U.S. Pat. No. 2,039,624 to Bigelow, U.S. Pat. No. 2,283,529 to Bobrick, U.S. Pat. No. 2,605,021 to Churchill et al., U.S. Pat. No. 2,622,539 to Martin, U.S. Pat. No. 3,233,411 to Schubert, U.S. Pat. No. 3,580,429 to Trindle, U.S. Pat. No. 3,952,918 to Poistras et al., and U.S. Pat. No. 6,161,773 to King introduce fluid dispensing apparatuses that discharge measured amount of fluid.

Among the prior arts, U.S. Pat. No. 2,039,624 is most close to the current application. It utilizes two valves, 22 and 24, that block both ends of measuring chamber 14. Valve 22 is larger than valve 24. Measuring chamber 14 has an enlarged bore 27 and a shoulder 28 to securely meet valve 22. Valve 24 is smaller than valve 22 and they securely meet at the main bore 30. When the spring 34 is fully extended, valve 22 is engaged to the larger bore 27 to close one end of the measuring chamber 14. That end is exposed to the liquid supply chamber 12. As the spring 34 is pressed, rod 26 pushes valve 22 into the liquid supply chamber 12 direction. When valve 22 comes out of the enlarged bore 27 and reaches inside of the liquid supply chamber, the liquid therein starts to flow into the measuring chamber 14. At this moment, the other valve 24 reaches the inside of the main bore and holds the liquid coming into the measuring chamber 14.

As a user removes pressure to the spring 34, valve 22 returns into the extended bore 27, and the other valve 24 comes out of the main bore 30. The liquid, accompanied by valve 24, comes out of the measuring chamber 14. The major drawback of the '624 is that when the liquid starts to get in the measuring chamber 14, the air previously filled in the chamber 14 may be trapped therein because the liquid comes in from every direction. The amount of the trapped air in the measuring chamber 14 is not consistent. That means the amount of liquid that comes out is not consistent, which is quite different from the purpose of the invention.

To eliminate such drawbacks KANG, Jun-seong filed a Korean Patent, Application No. 10-2002-0021187 and Publication No. P-2003-0082726. Another similar Korean Patent Application was filed by Hong, Chun-gang, Application 10-2003-0094843 and World Patent Application WO 2005/061365. Both patent applications utilize the same mechanism illustrated in the U.S. Pat. No. 2,039,624. The only difference is that the measuring chamber is placed vertically and a lever that is widely used in beverage dispensers actuates the spring.

In all prior art for liquid dispensers, the liquid comes in contact with the spring on the way to discharge, except for the '624. Contact between drinking water and the spring may not cause severe problems at the present time, but if the liquid is acidic or contains corrosive materials such as Chlorine, Bromine and Fluoride, the spring will be corroded and may cause severe problems, such as a change in the color of the liquid.

U.S. Pat. No. 1,066,753 to Rast, U.S. Pat. No. 2,505,697 to Vomacka, and U.S. Pat. No. 4,004,719 to Weitzman illustrate dispensers that discharge merchandise in a storaging chamber. The volume of a receptacle limits the number of merchandise discharged.

That solid merchandise dispenser cannot discharge a measured amount of liquid.

U.S. Pat. No. 4,109,835 to Castro, U.S. Pat. No. 4,232,718 to Wippermann, U.S. Pat. No. 4,531,658 to Galopin, U.S. Pat. No. 5,529,219 to Ward, U.S. Pat. No. 5,642,762 to Greenberg et al., U.S. Pat. No. 5,685,460 to Vlastuin, U.S. Pat. No. 6,308,860 to Eagle, and U.S. Pat. No. 6,951,294 to Laberinto illustrate a granule dispenser of measured amount.

The amount of discharged powder or the receptacles, which are used to dump out the contents to the final usages, limit granule.

None of the prior art illustrates a dispenser for liquid that does not cause problems due to the chemical properties of the liquid and that measures exact amounts, irrespective of the kind of liquid, as shown in the current application.

### SUMMARY OF THE INVENTION

Most liquid dispensers control the amount of the dispensed liquid by observation. Some kinds of electric dispensers control the amount of liquid dispensed by measuring the weight of the cup and contents, such as a mouth washing water dispenser at a dental clinic. However, those electrically controlled dispensers require an electrical pump, solenoid valves, and a microprocessor. Such equipment is expensive. Another type of dispenser for dispensing a measured amount is a powder dispenser. However, those dispensers cannot handle liquid in a precise amount. It is the purpose of the current application to provide a cheap and easy-to-handle dispenser that can discharge a precise amount of various liquids from its containers with simple operation. The liquids in the reservoir may be water, liquid medicine, and/or corrosive chemicals. The dispenser of the current application is comprised of a) a long cubic module having an open space of straight pipe which is developed vertically between the middle and rear side thereof, b) a guiding case for the long cubic module that surrounds the module with five walls and has a receptor for a liquid container and an air hole on the upper wall, c) a telescopic plastic case located horizontally on inside of the rear wall of the guiding case, and d) a spring placed inside of the telescopic plastic case. Two O-rings are engaged to two O-ring grooves that are developed at both ends of the open space of the straight pipe. The volume of the open space of straight pipe is adjusted by inserting an inert ball of known volume.

### BRIEF DESCRIPTION OF THE DRAWINGS

FIG. 1 is a perspective view of a liquid dispenser of the current application engaged to a dispenser housing.

FIG. 2 is a schematic drawing of the steps for engaging a liquid container to the dispenser of the current application and installing inside of the dispenser housing.

FIG. 3 is a perspective view of a liquid dispenser discharging measured amounts of various liquid from its container of the current application.

FIG. 4 is an exploded view of a liquid measuring module of the dispenser of the current application.

FIG. 5 is a schematic cross sectional view of the liquid measuring module having an inert ball inside thereof to reduce the discharging volume.

FIG. 6-a is a cross-sectional view of the liquid dispenser of the current application shown along line A-A′ in FIG. 3 when the spring is fully extended and the liquid from a container is introduced into the empty space of the straight pipe of the liquid measuring module.

FIG. 6-b is a cross-sectional view of the liquid dispenser of the current application shown along line A-A′ in FIG. 3 when the spring is fully retracted and the liquid in the space of the straight pipe of the liquid measuring module is discharged.

FIG. 7 is a side view of a surface tension decreaser developed on the upper surface of the guiding case and inside of a container receiver.

FIG. 8 is a front view of the guiding case without the liquid measuring module showing the spring case placed inside of the rear wall of the case.

FIG. 9 is an inside view of the upper wall of the guiding case showing the surface tension decreaser and an air hole.

FIG. 10 is an inside view of the lower wall of the guiding case showing a discharging funnel and a square opening.

### DETAILED DESCRIPTION OF THE PREFERRED EMBODIMENT

Most liquid dispensers as of now are designed to turn a liquid container upside down after opening the lid of the container, and then inserting the neck of the container to the dispenser. Following these steps, the contents of the container used to spill out. It is one of the purposes of the current application to provide a liquid dispenser that does not need to turn the liquid container upside down.

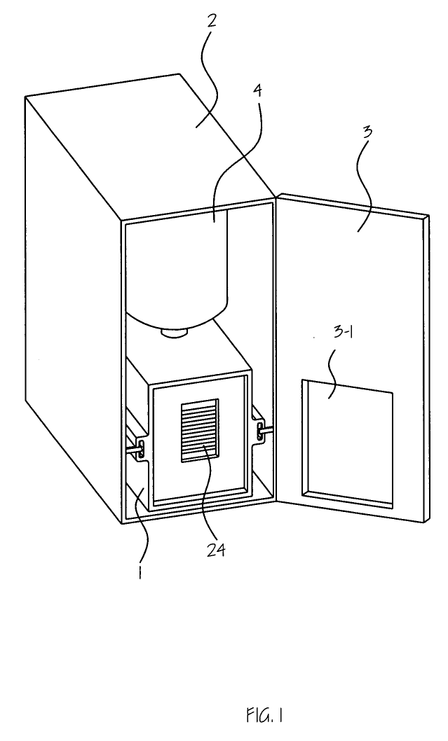

FIG. 1 is a perspective view of a liquid dispenser (1) of the current application engaged to a dispenser housing (2). The housing has an opening cover (3) at the front face. A window (3-1) is developed on the cover (3) to allow a user to reach the liquid dispenser (1). A liquid container (4) is placed on the liquid dispenser (1) up side down.

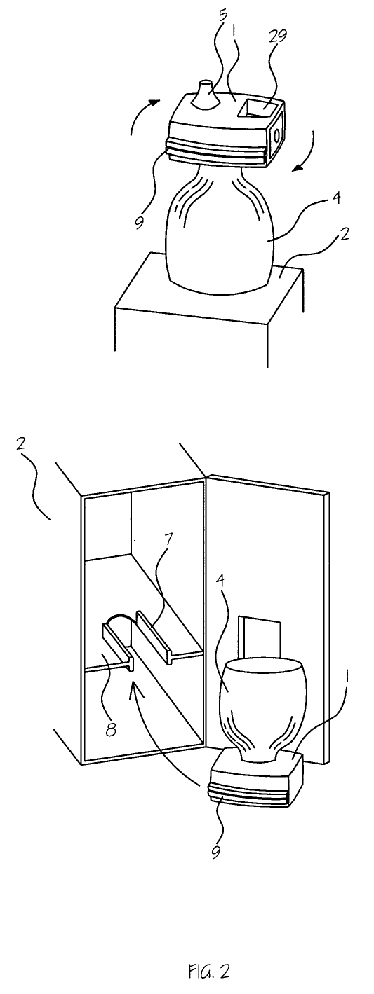

FIG. 2 is a schematic drawing of the steps for engaging a liquid container (4) to the liquid dispenser (1) of the current application and installing inside of the dispenser housing (2). The liquid dispenser (1) of the current application is designed to make it easy to engage the liquid container (4) to the liquid dispenser (1). The first step is open the lid of the liquid container (4) in an up-right position and engage the liquid dispenser (1) as up-side-down to the liquid container (4). In this position, the discharging funnel (5), through which the liquid is dispensed, faces up. Turn the liquid dispenser (4) clockwise along the threads (6) developed inside of the container receiver (12). Once the liquid dispenser (1) is engaged to the liquid container (4), turn the container (4) with dispenser (1) up-side-down and insert them along the rail (7). The rail is developed on a barrier (8) inside of the housing (2) and receives the groove (9), which is formed along the outside of the side walls and rear wall of the liquid dispenser (1).

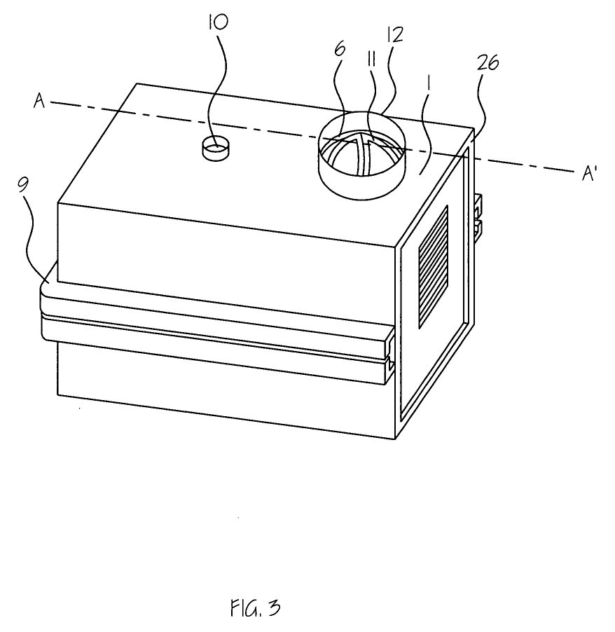

FIG. 3 is a perspective view of a liquid dispenser (1) discharging measured amounts of various liquids from the container of the current application. An air hole (10) and a liquid container receiver (12) are developed on the upper wall of the liquid dispenser (1). A surface tension decreaser (11) is developed inside of the receiver (12) to facilitate a transfer of the liquid from the container (1) to the liquid measuring module (13).

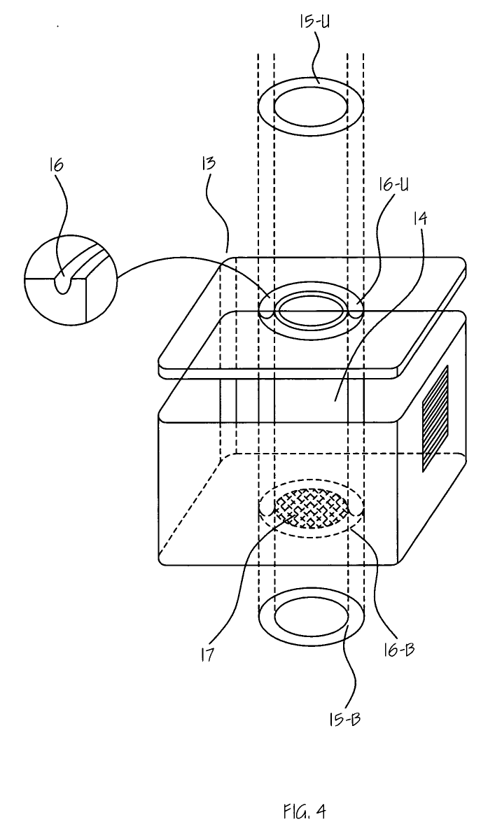

FIG. 4 is an exploded view of a liquid measuring module (13) of the dispenser (1) of the current application. The liquid measuring module (13) is a long cubic module that has an open space of straight pipe (14), which is developed, vertically between the middle and rear side thereof. Two ‘O’-rings (15-U) and (15-B) are engaged to two ‘O’-ring grooves (16-U) and (16-B). One ‘O’-ring groove (16-U) is developed on the upper surface and the other ‘O’-ring groove (16-B) is developed on the bottom surface of the module (13). These ‘O’-rings (16-U) and (16-B) prevent liquid from leaking out from inside of the straight pipe (14). A mesh (17) may be installed at the lower end of the straight pipe (14). The volume or amount of the liquid measured is fixed by the inner volume of the straight pipe (14).

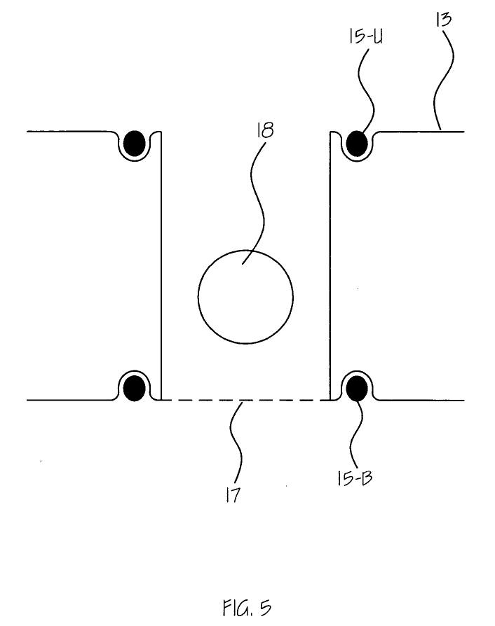

Another feature of the liquid dispenser (1) of the current application is that the discharging volume is easily adjusted without major change to the dispenser (1). FIG. 5 is a schematic cross-sectional view of the liquid measuring module (1) having an inert ball (18) inside thereof to reduce the discharging volume. The ball (18) is made of same material as the straight pipe (14), which is inert to the liquid. If the ball is (18) made of different material from the pipe (14), it should be inert to the liquid, and the volume of the ball (18) must be known. By inserting a ball (18) of a different volume, the discharging volume of the dispenser is easily changed. The mesh (17) at the bottom of the straight pipe (14) holds the ball (18) inside of the pipe (14).

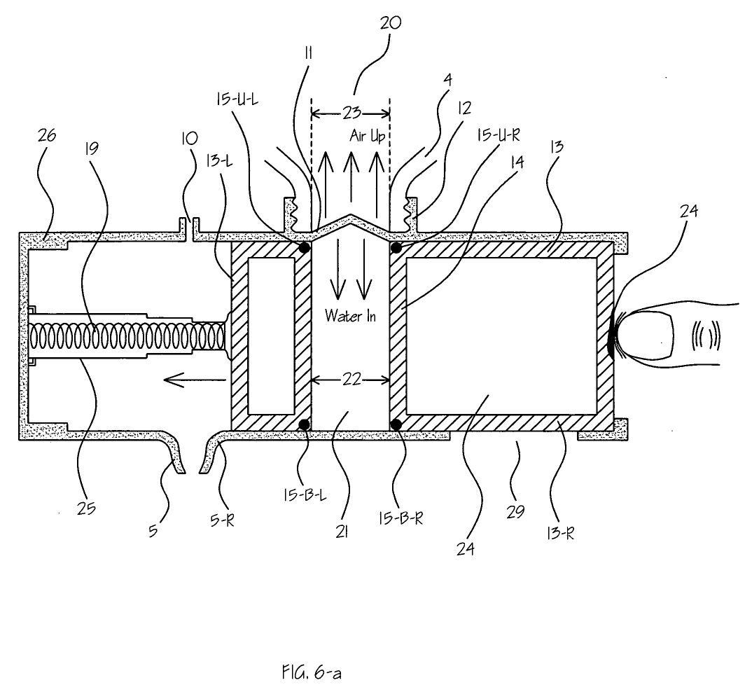

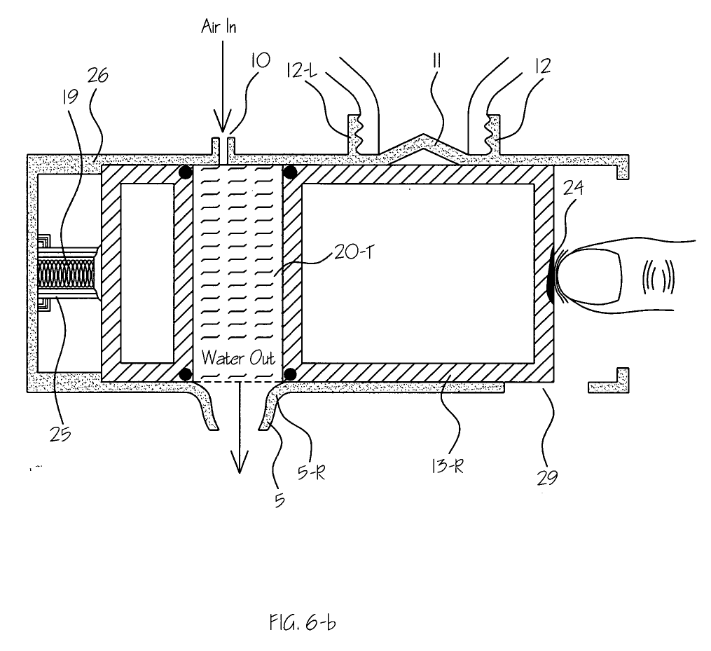

FIG. 6-a and 6-b show how the liquid dispenser (1) of the current application discharges the same desired amount of liquid every time. FIG. 6-a is a cross-sectional view of the liquid dispenser (1) of the current application shown along line A-A′ in FIG. 3 when the spring (19) is fully extended. Then the liquid (20) from a container (4) is introduced into the empty space (21) of the straight pipe of the liquid measuring module (13). At this position, the straight pipe (14) of the measuring module (13) locates directly under the liquid container (4) receiver (12). The inner-diameter (22) of the straight pipe (14) is the same as the inner-diameter (23) of the straight pipe (14). The liquid (20) in the container (4) flows down to the empty space (21) of the measuring module (13). The role of the surface-tension decreaser (11) is to facilitate the flow of the liquid into the empty space (21) when the liquid has high surface tension, compared to the liquid and the inner-diameter (22) of the neck of the liquid container (4). When the inner-diameters, (22) and (23), of the neck of the liquid container (4) and the straight pipe (14) are larger than 2 cm, and the liquid is water, the water flows down smoothly into the straight pipe (14) without the aid of the surface-tension decreaser (11). Therefore, if the dispenser is used for water or another liquid that has similar properties as that of water, and the neck diameter is larger than 2 cm, the surface-tension decreaser is not necessary.

When a user presses the touch point (24), the spring (19) in a telescopic plastic case (25) starts to retract. Then the measuring module (13) slides to the inner-side of a guiding case (26) for the liquid measuring module (13). The guiding case (26) surrounds the module (13) with five faces and has a screwed receptor (12) for a liquid container (4). By the time the left sides, (15-U-L) and (15-B-L), of the ‘O’-rings (15-U) and (15-B), seen in the FIG. 6-a and 6-b, reaches to the right edge (5-R) of the discharging funnel (5), the right sides, (15-U-R) and (15-B-R), of the ‘O’-rings (15-U) and (15-B) pass by the left side (12-L) of the receiver (12). Therefore, when the liquid (20-t) trapped in the straight pipe (14) starts to discharge through the discharging funnel (5), the opening of the container receiver (12) is blocked by the right side (13-R) of the measuring module (13). For this function, the front side (13-R) of the measuring module (13) is 2.5 times longer than the rear side (13-L) of the module (13). FIG. 6-b is a cross-sectional view of the liquid dispenser (1) of the current application shown along line A-A′ in FIG. 3 when the spring (19) is fully retracted and the liquid (20-t) in the space of the straight pipe (14) of the liquid measuring module (13) is discharged. The air hole (10) developed above facilitates the discharge of the liquid (20-t) through the discharging funnel (5). Moisture smeared between the ‘O’-rings of (15-U) and (15-B) acts as a slipping agent that makes the module (13) slide smoothly in and out.

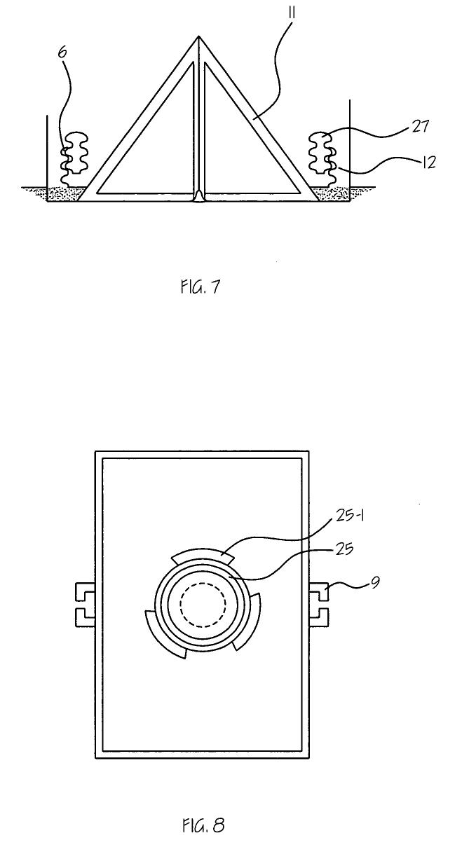

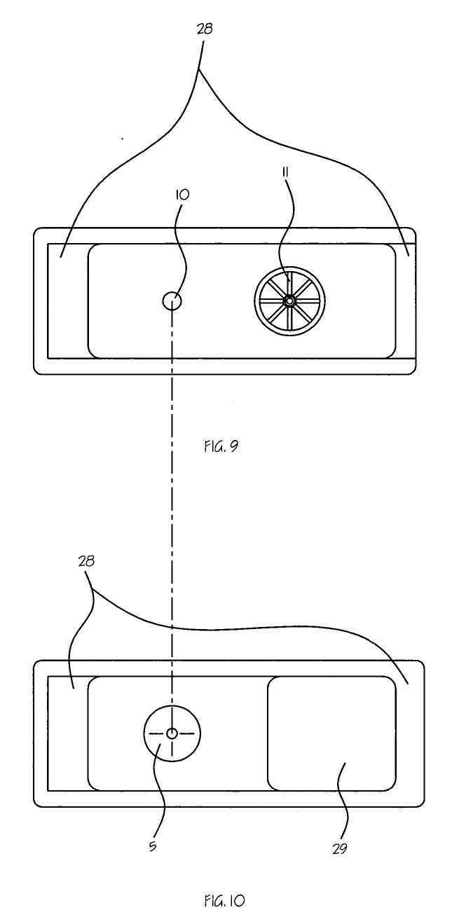

FIG. 7 is a side-view of a surface tension decreaser (11) developed on the upper wall of the guiding case (26) and inside of a container receiver (12). An adapter (27) may be applied to receive a liquid container, whose neck has a thread that does not fit to thread (6) of the container receiver (12) of the current application. FIG. 8 is a front view of the guiding case (26) without the liquid measuring module (13) showing the spring case (25) placed inside of the rear wall of the case (26) via a fixer (25-1). FIG. 9 is an inside view of the upper wall of the guiding case (26) showing the surface tension decreaser (11) and an air hole (10). FIG. 10 is an inside view of the lower wall of the guiding case (26) showing a discharging funnel (5) and a square opening (29). Contaminants such as sweat and dirts from the user's finger pass through the opening (29) and fall to the ground. Shoulders (28) developed at both ends of the inside of the upper wall and lower wall limit the movement of the liquid measuring module (13).

What is claimed is:

1) A dispenser to discharge a measured amount of liquid from a reservoir comprised of;
a) a long cubic module for measuring liquid volume having
an open space of straight pipe which is developed vertically between the middle and left side thereof, and
an inert ball inserted in the straight pipe to adjust the discharging amount of the liquid, and
two O-rings that are engaged to two O-ring grooves which are developed at both ends of the open space of the straight pipe, and
a screen mesh that is installed at the lower open end of the straight pipe; and
b) a guiding case for the long cubic module that surrounds the module with five walls of two side walls, upper wall, lower wall and rear wall and having
a screwed receptor for the liquid container and an air hole on the upper wall, and
an adaptor applied to the receptor to receive a liquid container, whose neck has a thread that does not fit to the screw thread of the container receiver, and
shoulders developed at both ends of the inside of the upper wall to limit the movement of the liquid measuring module, and
a square opening developed at the front side of the lower wall, and
shoulders developed at both ends of the inside of the lower wall to limit the movement of the liquid measuring module and
a groove, which is formed along the outside of the side walls and rear wall thereof; and
c) a telescopic plastic case located horizontally on inside of the rear wall of the guiding case; and
d) a spring placed inside of the telescopic plastic case.

2. A dispenser to discharge a measured amount of liquid from a reservoir of claim 1, wherein the straight pipe is a cylindrical straight pipe.

3. A dispenser to discharge a measured amount of liquid from a reservoir of claim 1, wherein the straight pipe is a square pipe.
